(19) United States
(12) Patent Application Publication
(10) Pub. No.: US 2016/0101566 A1
(43) Pub. Date: Apr. 14, 2016

(54) METHOD AND APPARATUS FOR FORMING A MULTI-COLORED THREE-DIMENSIONAL OBJECT USING A SECONDARY COLORIZATION PROCESS

(71) Applicant: HON HAI PRECISION INDUSTRY CO., LTD., New Taipei (TW)

(72) Inventors: EDWARD JOHN VAN LIEW, Santa Clara, CA (US); ERNEST DALE JENKINS, Santa Clara, CA (US); JOSEPH ALAN WOLFMAN, Santa Clara, CA (US)

(21) Appl. No.: 14/509,635

(22) Filed: Oct. 8, 2014

(51) Int. Cl. B29C 67/00; B29C 71/00

(52) U.S. Cl. CPC B29C 67/0085; B29C 67/0055; B29C 71/00; B29K 2067/046

(57) ABSTRACT

A method of forming a 3D multi-colored object is described. The exemplary method includes two steps. The first step is forming the size and shape of the object using an extrusion process. The second step is applying a color to the object using a colorization process. An apparatus for forming the 3D multi-colored object is also described. The apparatus includes an object support, a first nozzle and a second nozzle. The first nozzle is for extruding a material that forms the size and shape of the object. The second nozzle is for applying a colorant to the object for coloring the object.

### FIELD

The present disclosure relates to methods of 3D printing.

### BACKGROUND

Existing consumer based “Three-Dimensional printing” machines allow only one color per object. The filament is one color (for example, red) and entire object is produced in that color.

Commercial based 3D printing machines having multi-color capability use colored resins deposited onto a powder substrate. This is done layer by layer of powder to create the finished output. At the end of the process, this process then requires the end object be cleaned of excess powder.

### BRIEF DESCRIPTION OF THE DRAWINGS

Implementations of the present technology will now be described, by way of example only, with reference to the attached figures.

FIG. 1 is a flowchart of an exemplary method for forming a multi-colored 3D object using a secondary colorization process.

FIG. 2 is a diagrammatic view of an apparatus for forming a multi-colored 3D object using a secondary colorization process.

FIG. 3 shows apparatus 100 carrying out a first step of the exemplary method.

FIG. 4 shows apparatus 100 carrying out a second step of the exemplary method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”; it specifically indicates open-ended inclusion or membership in a so-described combination, group, series and the like.

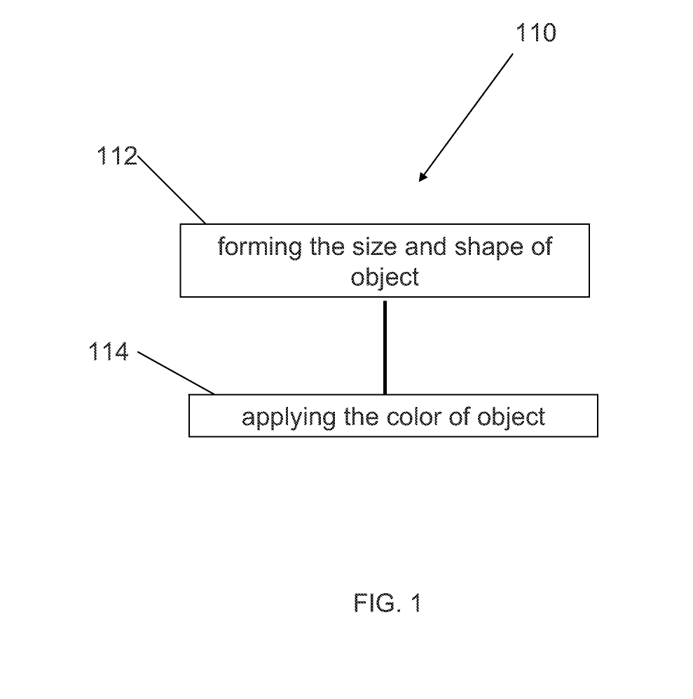

FIG. 1 is a flowchart of an exemplary method 110 for forming a multi-colored 3D object using a secondary colorization process.

The object is intended to be a copy of a base object. The base object can be an actual physical 3D multi-colored object which is “copied” in the manner of a 3D copying system by the exemplary method described herein. Alternatively, the base object can comprise a virtual 3D multi-colored object in the form of data file representing the base object and then printed in the manner of a 3D printing system by the exemplary method described herein.

The exemplary method 110 comprises forming the size and shape of the object (block 112). The forming the size and shape can typically be performed by continuously extruding a molten base filament until the final size and shape of the object is formed. The molten base filament can comprise polyactic acid, (also known as “PLA”). The raw molten base filament cannot be colored (that is, colorless) or can be of a color not representative of the final object to be created.

The method 110 also comprises applying the color to the object using a colorization process (block 114). The colorant (also known as, color supplies) used in the colorization process can come in a variety of forms. The colorant can be a liquid ink or a liquid dye. The colorants can also be in RGB, CMYK or any other color spaces.

According to the exemplary method, the applying the color is only conducted to portions of the copy that are visible in the final copy. The method 110 presented herein uses far less colorant than the prior art methods where colored resins are deposited onto a powder substrate and then extruded layer by layer.

Furthermore, according to the exemplary method, the applying the color is conducted after the completion of the forming the size and shape and as a secondary colorization process. Accordingly, the mixing of the extrusion material and the colorant can be avoided.

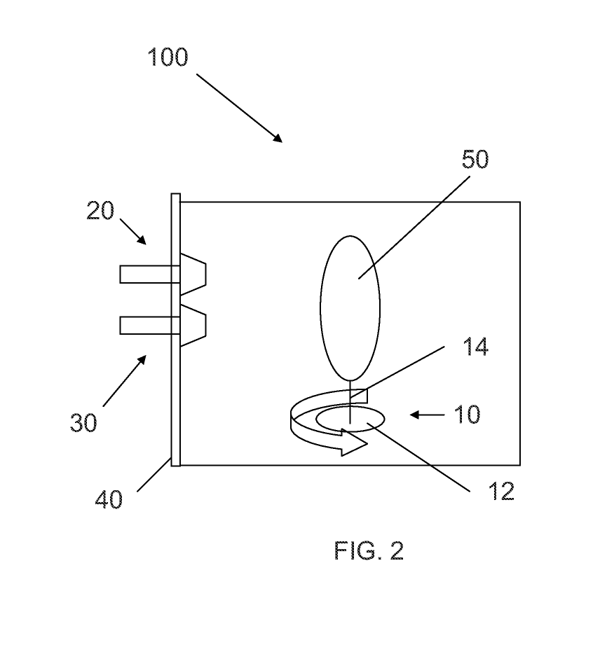

FIG. 2 is a diagrammatic view of an apparatus for forming a multi-colored 3D object using a secondary colorization process.

The apparatus 100 for forming the 3D multi-colored object includes an object support 10. The object support 10 can include a rotating portion 12 and a support portion 14. The object 50 being formed can be supported on support portion 14. Rotating portion 12 allows for rotating the object 50 so that all parts of the object 50 can be in the path of the materials flowing out of the nozzles. Furthermore, while in FIG. 2 the object support 10 is shown as rotatable about a vertical axis, the object support 10 can also or alternatively be rotatable about a horizontal or any other axis.

Apparatus 100 further includes a first nozzle 20. The first nozzle 20 can be for extruding the material that forms the size and shape of the object. As described above with respect to the exemplary method, the extrusion material can be a molten filament material.

Apparatus 100 further includes a second nozzle 30. The second nozzle can be for applying a colorant to the object for coloring the object. As described above with respect to the exemplary method, the colorant can be one of a liquid ink or liquid dye. Different colored colorant can be sequentially and continuously applied to object A to form the multi-colored object.

Apparatus 100 further includes a nozzle support 40. The first nozzle 20 and the second nozzle 30 are mounted to the nozzle support 40. While the location of nozzle support 40 can be varied from that shown in the FIG. 2, the first nozzle 20 and the second nozzle 30 can be mounted adjacent (or next) to each other on the nozzle support 40.

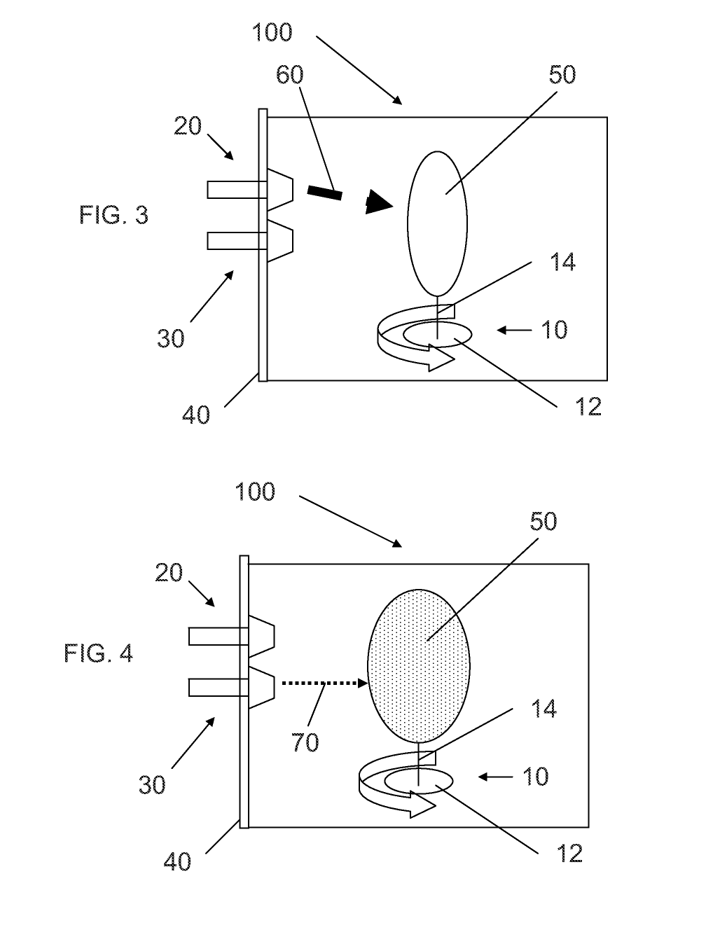

FIG. 3 and FIG. 4 illustrate an exemplary apparatus 100.

In FIG. 3, the extrusion material 60 is ejected out of a first nozzle 20 to form object 50. While object 50 is shown as a simple ovoid, it can have any size and shape.

In FIG. 4, the size and shape of object 50 is completed. Visually, this is simply shown in FIG. 4 by object 50 being shown larger in FIG. 4 than it is shown in FIG. 3. At this point the forming step is completed. Colorant 70 is then ejected out of a second nozzle 30 and onto object 50 to apply the color to object 50. The coloring is represented by the stippling shown in object 50. Finally, arrow 70 is shown as finer than arrow 60 to show that, typically, colorant 70 will be a finer, more misty spray, than the typical thick molten filament extrusion 60.

According to the exemplary apparatus and method, the forming the size and shape of the object and the applying the color to the object are conducted without relocating the object. Accordingly, the exemplary apparatus and method are simple, takes less time than other methods, and is cleaner because the partially formed object need not be handled.

Furthermore, according to the exemplary apparatus and method, the forming the size and shape of the object is conducted using a first nozzle, the applying the color to the object is conducted using a second nozzle, and the first and second nozzles are adjacent to each other. By “adjacent”, it is intended that the first and second nozzles be next to each other. This can be achieved by mounting the first and second nozzles to a common frame and adjacent to each other.

The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including, the full extent established by the broad general meaning of the terms used in the claims.

What is claimed is:

1. A method of forming a three-dimensional multi-colored object comprising:
forming the size and shape of the object by extruding from a nozzle of a three-dimensional printing device an object having a desired size and shape; and
applying a color to the object to apply the object's exterior color.

2. The method of claim 1, wherein the step of apply the color is only done on portions of the object that are visible in a final object.

3. The method of claim 1, wherein the step of applying the color is conducted after the completion of the step of the size and shape of the object.

4. The method of claim 1, wherein the step of forming the size and shape of the object and the step of applying the color are conducted without relocating the object.

5. The method of claim 1, wherein the step of forming the size and shape is conducted using a first nozzle, the step of applying the color is conducted using a second nozzle, and the first and second nozzles are adjacent to each other.

6. The method of claim 1, wherein the step of forming the size and shape is conducted using a first nozzle, the step of applying the color is conducted using a second nozzle, and the first and second nozzles are next to each other.

7. The method of claim 1, wherein the step of forming the size and shape is conducted using a first nozzle, the step of applying the color is conducted using a second nozzle, and the first and second nozzles are mounted to a common frame and adjacent to each other.

8. An apparatus for forming a object, comprising:
an object support;
a first nozzle, the first nozzle for extruding a material that forms an object having a predetermined size and shape; and
a second nozzle, the second nozzle for applying a colorant of a predetermined color to the object.

9. The apparatus of claim 8, wherein:
the extrusion material is a molten filament material; and
the colorant is one of a liquid ink or liquid dye.

10. The apparatus of claim 8, further comprising a nozzle support and the first and second nozzles are mounted to the nozzle support.

11. The apparatus of claim 10, wherein the first nozzle and the second nozzle are mounted adjacent to each other on the nozzle support.
